(19) United States
(12) Patent Application Publication
(10) Pub. No.: US 2024/0265170 A1
(43) Pub. Date: Aug. 8, 2024

(54) GROUNDWATER REMEDIATION WELL GROUP LAYOUT METHOD AND APPARATUS, COMPUTER DEVICE, AND STORAGE MEDIUM

(71) Applicant: CHINESE RESEARCH ACADEMY OF ENVIRONMENTAL SCIENCES, Beijing (CN)

(72) Inventors: Changjian Shang, Beijing (CN); Yongfeng Jia, Beijing (CN); Yonghai Jiang, Beijing (CN); Yongge Zang, Beijing (CN); Xinying Lian, Beijing (CN); Zehan Zhang, Beijing (CN)

(21) Appl. No.: 18/510,418

(22) Filed: Nov. 15, 2023

(30) Foreign Application Priority Data
Feb. 6, 2023 (CN) 2023100678023

(51) Int. Cl. G06F 30/20

(52) U.S. Cl. CPC G06F 30/20; G06F 2111/04; G06F 2111/10; G06F 2113/08

(57) ABSTRACT

A method of groundwater remediation well group layout includes: determining N groups of random data and N groups of well position coordinates by means of random and preset constraint conditions of multi-objective optimization NSGA-II algorithm, inputting each group of random data into target function, and calculating fund data and time data respectively corresponding to each group of random data; inputting each group of random data and the corresponding water well position coordinates into groundwater flow field distribution and solute transport model, so that the pollutant concentration after groundwater remediation is obtained through simulation; determining the random data with the pollutant concentration less than or equal to the repair target value after the polluted groundwater is repaired and the corresponding water well position coordinates as the hydraulic control and water and soil cooperative well group layout parameters of the polluted groundwater.

### CROSS-REFERENCE TO RELATED APPLICATION(S)

This application claims the benefit of priority to Chinese Application No. 2023100678023, filed on 6 Feb. 2023, the contents of which are incorporated herein by reference in their entirety.

### Technical Field

The present application relates to the technical field of water environments, and in particular, to a method of groundwater remediation well group layout.

### BACKGROUND

### Description of the Related Art

With the development of social economy, contaminated sites of soil and groundwater are increasing, and the degree of contamination is increasingly heavier, and the depth of contamination is increasingly deeper. The polluted soil and groundwater are repaired by a strategy of respectively repairing the wrapping tape and the aquifer, so that the repairing engineering process is complex, and the cost is large. The polluted groundwater extraction-treatment technology is widely applied to groundwater risk management and control and repair, and is a mature technology. Since soil and groundwater are not considered in a unified manner in early stage, extraction treatment only exists as a remediation technology for groundwater, and is mainly used for pollution source reduction, pollution plume control, pollution plume remediation and the like, while less consideration is given to contaminated soil. The contaminated soil often contains a large amount of pollutants, resulting in tailing and rebound phenomena of groundwater remediation. The extraction-treatment technology controls the flow field through the pumping-injection well group, which can repair the polluted soil groundwater, while the number, position and flow of the pumping-injection well are the key to affect the effect of the extraction-treatment repair technology.

Based on the above analysis, how to develop a method of optimal pumping and injection well group layout for groundwater hydraulic control and water and soil cooperation is a key for efficient remediation of contaminated soil and groundwater.

### BRIEF SUMMARY

An embodiment of the present application provides a method of groundwater remediation well group layout, includes:
determining N groups of random data and N groups of well position coordinates by means of random and preset constraint conditions of multi-objective optimization NSGA-II algorithm, each group of random data includes the number of water pumping wells, the number of water injection wells, the state variables of water wells, the flow of water pumping wells, the flow of water injection wells, the running time of water pumping wells, and the running time of water injection wells; the number of wells in each group is the sum of the number of water pumping wells and the number of water injection wells;
inputting each group of random data into target function, and calculating fund data and time data respectively corresponding to each group of random data;
inputting each group of random data and the corresponding water well position coordinates into groundwater flow field distribution and solute transport model, so that the pollutant concentration after groundwater remediation is obtained through simulation;
determining the random data with the pollutant concentration less than or equal to the repair target value after the polluted groundwater is repaired and the corresponding water well position coordinates as the well group layout parameters of the polluted groundwater repairing.

### BRIEF DESCRIPTION OF THE DRAWINGS

FIG. 1 is flowchart of a method of groundwater remediation well group layout according to the present application;

FIG. 2 is flowchart of another method of groundwater remediation well group layout according to the present application;

FIG. 3 is diagram of time-fund cost optimization result according to the present application;

FIG. 4 is diagram of optimized well group layout according to the present application;

FIG. 5 is diagram of time-fund cost optimization result according to another embodiment of the present application;

FIG. 6 is diagram of optimized well group layout according to another embodiment of the present application;

FIG. 7 is schematic structural diagram of groundwater remediation well group layout apparatus according to the present application; and

FIG. 8 is schematic diagram of computer device according to the present application;

### DETAILED DESCRIPTION

In order to further understand the above technical solutions, the technical solutions of the embodiments of this application are described in detail below with reference to the accompanying drawings and specific embodiments, it should be understood that the embodiments of this application and the specific features in the embodiments are detailed descriptions of the technical solutions of the embodiments of this application, and are not limited to the technical solutions of this application, and in the case of no conflict, the embodiments of the present application and the technical features in the embodiments may be combined with each other.

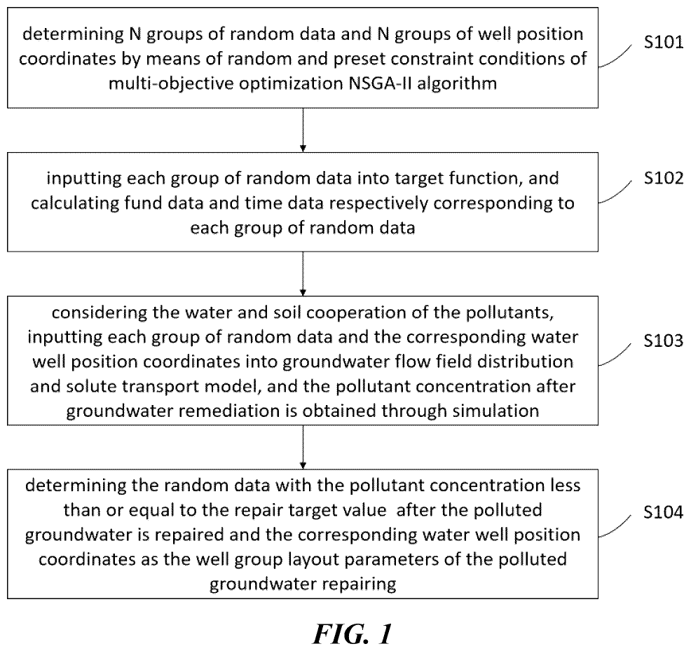

Please refer to FIG. 1, which is a method of groundwater remediation well group layout according to an embodiment of the present application, performing step S101 to step S104:

Step S101: determining N groups of random data and N groups of well position coordinates by means of random and preset constraint conditions of multi-objective optimization NSGA-II algorithm.

Wherein, each group of random data includes the maximum number of water pumping wells, the maximum number of water injection wells, the state variables of water wells, the flow of water pumping wells, the flow of water injection wells, the running time of water pumping wells, the running time of water injection wells; the number of coordinates in each group of water wells position coordinates is the sum of the number of water pumping wells and the number of water injection wells.

For the constraint conditions, it is determined according to the repair target value and the hydrogeological condition of the site. The pollutants are redistributed in the pumping and injecting process so as to achieve soil and water cooperative remediation of the contaminated site. Specifically, the said preset constraint condition at least includes:

$${\sum }_{i = 1}^{{N}_{1}} {y}_{i} \vert {Q}_{i} \vert = {\sum }_{i = 1}^{{N}_{2}} {y}_{i} \vert {Q}_{o} \vert ;$$

$$max {S}_{o} \leq {H}_{b} ; and$$

$$max {S}_{i} \leq {H}_{h} ;$$

wherein, N₁ is the number of water pumping wells, N₂ is the number of water injection wells, yᵢ is the state variables of water wells, Qᵢ is the flow of water pumping wells; Qₒ is the flow of water injection wells, Sₒ is a water head rise value caused by water injection of water injection well; H_{b} is the thickness of the wrapping tape of the stratum; Si is a water head drop value caused by water pumping of water pumping well; H_{b} is the thickness of the aquifer of the stratum.

Step S102: inputting each group of random data into target function, and calculating fund data and time data respectively corresponding to each group of random data.

The objective function is a function of two targets considering both time and fund costs, the fund costs mainly considers the cost of construction of water pumping well and water injection wells as well as the running cost of water pumping and injecting, and the time considers the running time of water pumping wells and water injection wells.

In this embodiment of the present application, the said inputting each group of random data into target function, and calculating fund data and time data respectively corresponding to each group of random data, includes:

calculating the said fund data and the said time data through the following objective function:

$$J = {α}_{1} {\sum }_{i = 1}^{N} {y}_{i} {d}_{i} + {α}_{2} {\sum }_{i = 1}^{{N}_{1}} {y}_{i} \vert {Q}_{i} \vert {t}_{i} + {α}_{3} {\sum }_{i = 1}^{{N}_{2}} {y}_{i} \vert {Q}_{o} \vert {t}_{o}$$

$$T = max ( {t}_{i} , {t}_{o} )$$

wherein, J is fund data, T is time data, N is the number of water pumping wells and water injection wells, N₁ is the number of water pumping wells, N₂ is the number of water injection wells, yᵢ is the state variables of water wells, the value of y; is 0 or 1, 0 indicates that the well does not exist, and 1 indicates the presence of the well, di is the well-forming depth of the i-th well, Q; is the flow of water pumping wells, tᵢ is the running time of the i-th water pumping well, Qₒ is the flow of water injection wells, tₒ is the running time of the i-th water injection well, α₁ is the construction unit price of water pumping well and water injection well, α₂ is the running unit price of water pumping well, α₃ is the running unit price of water injection well. N, di α₁, α₂, α₃ are given known data.

The number of water pumping wells and water injection wells is the sum of the said number of water pumping wells and the said number of water injection wells, that is, N=N₁+N₂.

Step S103: considering the water and soil cooperation of the pollutants, inputting each group of random data and the corresponding water well position coordinates into groundwater flow field distribution and solute transport model, so that the pollutant concentration after groundwater remediation is obtained through simulation.

In an optional embodiment provided by the present application, the preset constraint condition in step S101 further includes: max Cₜ≤C₀, wherein Cₜ is an groundwater pollutant concentration value after repairing; C₀ is the repair target value. Before step $103, further includes: acquiring hydrogeological basic parameters required for modeling, the said hydrogeological basic parameters at least including geological data, hydrological data, pollutant data; simulating the groundwater flow field distribution and the solute transport model according to the said hydrogeological basic parameters simulation. The groundwater flow field distribution and solute transport model use FloPy module written in the Python language coupled with groundwater simulation software Modflow as well as solute transport module MT3DMS to perform numerical simulation. Then the simulation result is corrected according to the actual monitoring data, in order to meet the actual groundwater flow and pollution conditions.

Specifically, technicians use the FloPy module to input collected contaminated site related data (size of the contaminated site, hydraulic connection with the surrounding area, soil characteristics and thickness of each layer, rainfall and evaporation data), hydrogeological related data (hydraulic gradient, water level burial depth, water head, soil permeability coefficient in X, Y, Z direction, porosity, water storage coefficient or water supply degree), pollutant related data (pollutant name, pollution plume distribution, distribution coefficient of pollutants in water and soil, pollutant dispersion coefficient) into Modflow and MT3DMS to establish groundwater flow field distribution and solute transport model.

Collecting the geological parameters of the contaminated site, the hydrological parameters, and the pollutant related parameters includes: the collection time of the data, the length, width and height of the site of the polluted site simulation region, the thickness of each stratum, the burial depth of groundwater, the water flow direction of groundwater, the flow rate of groundwater, the hydraulic gradient, permeability in X, Y, Z direction of each stratum, the water supply degree and elastic water release coefficient; pollutant related parameters are mainly pollutant space distribution, type, concentration, distribution coefficient of soil and water, dispersion coefficient, etc.

Step S104: determining the random data with the pollutant concentration less than or equal to the repair target value after the polluted groundwater is repaired and the corresponding water well position coordinates as the well group layout parameters of the polluted groundwater repairing.

The pollutant concentration is not higher than the repair target value after the polluted groundwater is repaired may be expressed by formula max C≤C₀. C is the pollutant concentration after the polluted groundwater is repaired; C₀ is the repair target value.

The said groundwater hydraulic control means that the groundwater flow field formed by pumping and injection wells controls the pollutants in a set area and pollutants do not diffuse.

The said water and soil cooperation of the pollutants means that the pollutants have a distribution proportion in soil and groundwater, and the polluted soil of the aquifer is indirectly repaired by reducing the concentration of pollutants in the groundwater. The water and soil distribution of pollutants conforms to the following formula:

$$Kd = S / C$$

In the formula, Kd is the distribution coefficient L/kg; S is the adsorption quantity of the soil to the pollutants mg/kg; and C is the mass concentration of the solute in the water mg/L.

In this embodiment, NSGA-II algorithm is used to perform multiple iterative calculations to obtain an optimal solution set scatter diagram composed of a plurality of Pareto optimal solutions. The decision maker determines a specific Pareto optimal solution according to the weight of the determined funds and time. According to the repair process and the well location layout corresponding to the said optimal solution, an groundwater pollution plume change diagram and a well location layout scheme are obtained. Moreover, the groundwater flow field distribution mode is verified, which can truly reflect the relationship between funds and time under the condition of achieving a repair effect, which has a high visualization degree and is suitable for non-professionals. The decision maker can obtain an optimal operation scheme of a specific weight according to the actual situation (giving different weights to the fund cost and the time cost), and the decision maker can see the pollution plume change diagram of each repair time period, which facilitates the understanding of the repair process of the solution and improves the visibility of the repair technology and effect.

A method of groundwater remediation well group layout is provided by the present application, in which, first, determining N groups of random data and N groups of well position coordinates by means of random and preset constraint conditions of multi-objective optimization NSGA-II algorithm, each group of random data includes the maximum number of water pumping wells, the maximum number of water injection wells, the state variables of water wells, the flow of water pumping wells, the flow of water injection wells, the running time of water pumping wells, the running time of water injection wells; then inputting each group of random data into target function, and calculating fund data and time data respectively corresponding to each group of random data; inputting each group of random data and the corresponding water well position coordinates into groundwater flow field distribution and solute transport model, so that the pollutant concentration after groundwater remediation is obtained through simulation; determining the random data with the pollutant concentration less than or equal to the repair target value after the polluted groundwater is repaired and the corresponding water well position coordinates as the well group layout parameters of the polluted groundwater repairing. The well group layout parameters of the polluted groundwater remediation determined by the present application can truly reflect the relationship between funds and time under the condition of achieving a repair effect, thereby improving the remediation efficiency of groundwater hydraulic control and water and soil cooperation.

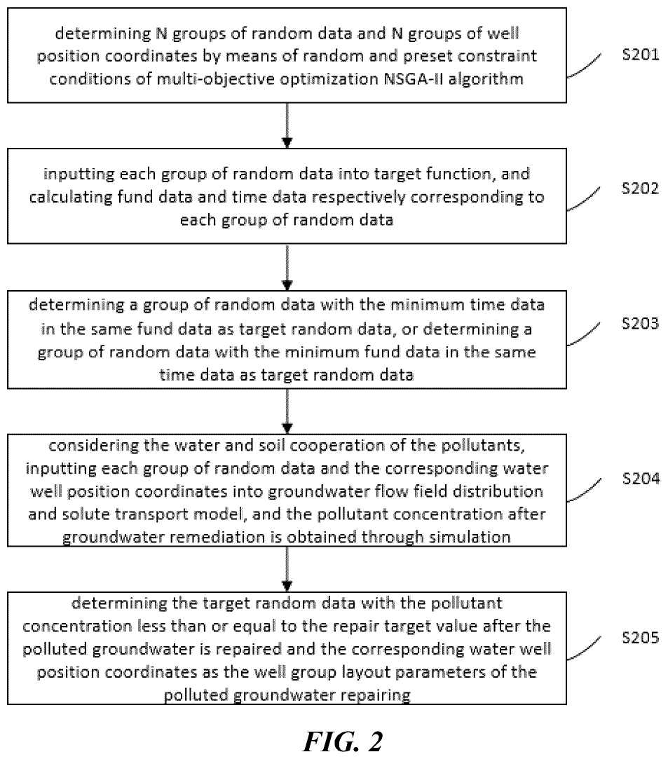

Please refer to FIG. 2, which is another method of groundwater remediation well group layout according to an embodiment of the present application, performing step S201 to step S205:

Step S201: determining N groups of random data and N groups of well position coordinates by means of random and preset constraint conditions of multi-objective optimization NSGA-II algorithm.

Wherein, each group of random data includes the maximum number of water pumping wells, the maximum number of water injection wells, the state variables of water wells, the flow of water pumping wells, the flow of water injection wells, the running time of water pumping wells, the running time of water injection wells; the number of coordinates in each group of water wells position coordinates is the sum of the number of water pumping wells and the number of water injection wells.

Step S202: inputting each group of random data into target function, and calculating fund data and time data respectively corresponding to each group of random data.

It should be noted that steps S201 to S202 in this embodiment are the same as those in the corresponding steps in FIG. 1, and details are not described herein again.

Step S203: determining a group of random data with the minimum time data in the same fund data as target random data, or determining a group of random data with the minimum fund data in the same time data as target random data.

Specifically, the same fund data or same time data may be determined first, then determining a group of random data with the minimum time data in the same fund data as target random data, or determining a group of random data with the minimum fund data in the same time data as target random data. That is, the target random data corresponding to the minimum time data in the same fund data is selected, or the target random data corresponding to the minimum fund data in the same time data is selected.

In one embodiment of the present application, when there is no same fund data and the same fund data do not exist, considering the water and soil cooperation of the pollutants, inputting all random data and the corresponding water well position coordinates into groundwater flow field distribution and solute transport model, then the pollutant concentration after groundwater remediation is obtained through simulation.

Step S204: considering the water and soil cooperation of the pollutants, inputting each group of random data and the corresponding water well position coordinates into groundwater flow field distribution and solute transport model, so that the pollutant concentration after groundwater remediation is obtained through simulation.

Step S205: determining the target random data with the pollutant concentration less than or equal to the repair target value after the polluted groundwater is repaired and the corresponding water well position coordinates as the well group layout parameters of the polluted groundwater repairing.

In this embodiment, firstly, collecting the geological parameters, the hydrological parameters, and the pollutant related parameters of the contaminated site, performing an underground water flow field and solute transport simulation, and obtaining a corresponding simulation result, and correcting and verifying the authenticity of the model. Then setting target function and constraint condition for well group optimization. Finally, using NSGA-II algorithm coupled with groundwater flow field, pollutant water and soil distribution, solute transport, optimization target, under the constraint of the constraint condition, the position and flow of water pumping well and water injection well with specific time and funds is found by NSGA-II algorithm through multiple iterative operations, and an optimization curve of time-funds can be obtained by changing time and funds. Fund cost and time cost is comprehensive implementation of groundwater remediation engineering, the optimal solution calculated by the NSGA-II algorithm corresponds to a series of well group layout information, including location and flow of each well. The specific solution is determined after different weights are given to the time and the fund, and then the repair process of the polluted groundwater and the well location layout diagram of groundwater pollution plume hydraulic control and water and soil cooperation are displayed.

In one application scenario provided in the embodiments of the present application, taking a certain site located in the East China region as an example. The site area is about 40 m*70 m, the elevation of the top plate of the submersible aquifer is 42.0 m, the elevation of the waterproof bottom plate is 36.0 m, the thickness of the aquifer is 6.0 m, the thickness of the wrapping tape is 4.0 m, the horizontal permeability coefficient of the aquifer is 3.0 m/d, the vertical permeability coefficient is 0.3 m/d, the specific yield is 0.12, the north part and the south part are fixed head boundaries, the east part and the west part are water-proof boundaries, the water heads are 42 m and 41.72 m, respectively, the collected hydrogeological parameters are detailed in Table 1 below.

TABLE 1

| porosity | 0.3 | |
|---|---|---|
| specific yield | 0.12 | |
| elevation of the top plate | 42 | m |
| elevation of the bottom plate | 36 | m |
| north water head | 42 | m |
| south water head | 41.72 | m |
| rainfall | 630 | mm/a |
| precipitation infiltration replenishment coefficient | 0.21 | |
| permeability coefficient Kx | 3 | m/d |
| permeability coefficient Kz | 0.3 | m/d |
| longitudinal dispersion | 20 | m |

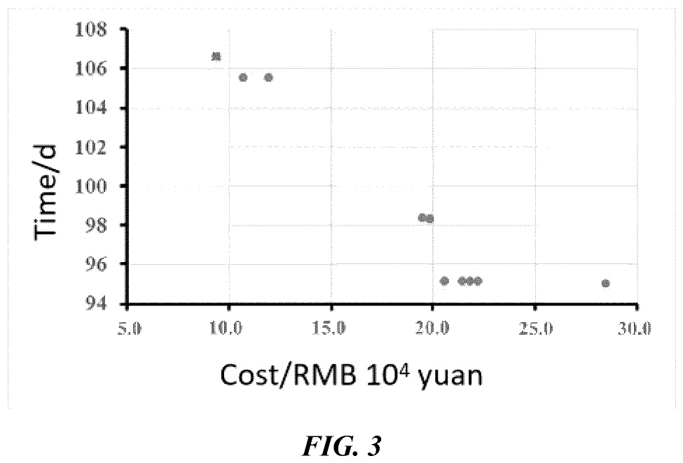

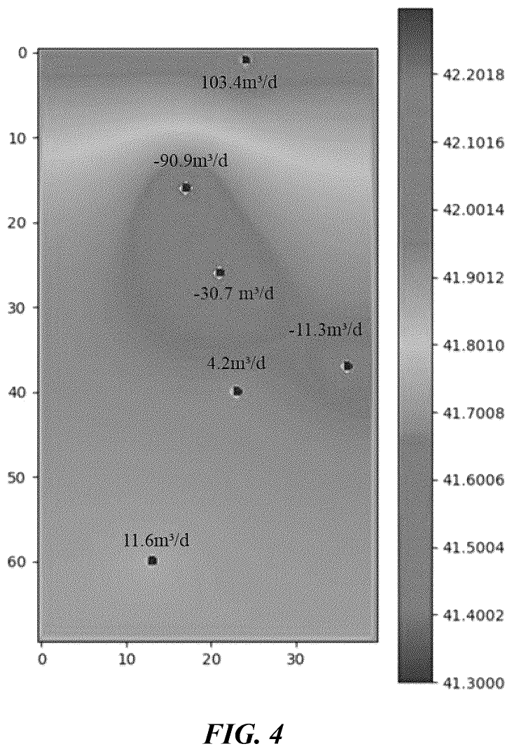

pollutant in groundwater is tetrachloroethylene with a maximum concentration of 800 μg/L, and a repair target value of 135 μg/L; the maximum content of tetrachloroethylene in the aquifer soil is 195 mg/kg, and the repair target value is 35 mg/kg. The organic carbon distribution coefficient (Koc) of tetrachloroethylene is 245 L/kg, and the organic carbon content of soil is 1%. In the case of repairing to the target value (the target value is the content in Table 2), the objective function is established with the minimum fund cost and the shortest time as the objective function:

$$Fund cost minimum : Min J = 4000 {\sum }_{i = 1}^{N} {y}_{i} + 2 {\sum }_{i = 1}^{N} {y}_{i} \vert {Q}_{i} \vert {t}_{i} + 4 {\sum }_{i = 1}^{N} {y}_{i} \vert {Q}_{o} \vert {t}_{o}$$

$$Time cost minimum : Min T = max ( {t}_{i} , {t}_{o} )$$

wherein, the single well construction price of pumping well and injection well is 4000 yuan (400 yuan/m*10 meters), the unit price of pumping is 2 yuan/m³, and the unit price of injection is 4 yuan/m³. Using NSGA-II algorithm, with initial population 100 and termination condition 50 generations, a series of Pareto optimal solutions are obtained (as shown in FIG. 3). According to the information available to the decision maker, the weight of fund cost and time cost is set to 1:1 in comprehensive consideration, and it is obtained that 3 water pumping wells and 3 water injection wells are used in the site (Table 3, FIG. 4), the repairing time is about 106 days, and the repair target can be achieved, and the fund cost is 95,200 yuan.

By setting the objective function, constraint conditions are established according to site conditions, the process of releasing aquifer pollutants to groundwater is also considered, then, a series of solutions of repair time and repair funds are calculated by using NSGA-II algorithm, from which the overall situation of time and funds is displayed, and for a specific optimal solution, a repair process is displayed.

TABLE 2

| | | |
|---|---|---|
| thickness of the wrapping tape H_{b} | 4 | m |
| thickness of the aquifer Hₕ | 6 | m |
| groundwater repair target value C₀ | 135 | μg/L |
| soil repair target value Cₛ | 35 | mg/kg |

TABLE 3

| number | | | | |
|---|---|---|---|---|
| sequence | X | Y | Q | type |
| 1 | 16 | 17 | −90.9 | pumping well |
| 2 | 26 | 21 | −30.7 | pumping well |
| 3 | 37 | 36 | −11.3 | pumping well |
| 4 | 40 | 23 | 4.2 | injection well |
| 5 | 60 | 13 | 11.6 | injection well |
| 6 | 1 | 24 | 93.4 | injection well |

In another embodiment of the present application, taking a certain site located in the North China region as an example. The site is irregularly shaped, and the site area is about 5000 m². The elevation of the top plate of the submersible aquifer is −8.40 m, the elevation of the waterproof bottom plate is −17.94 m, the thickness of the aquifer is 9.54 m, the thickness of the wrapping tape is 3.5 m, the horizontal permeability coefficient of the aquifer is 1.021 m/d, the vertical permeability coefficient is 0.1 m/d, the specific yield is 0.00012/m, the northwest part and southeast part are fixed head boundaries, the northeast part and the southwest part are water-proof boundaries, the water heads are −8.40 m and −8.75 m, respectively, the collected hydrogeological parameters are detailed in Table 4 below.

TABLE 4

| porosity | 0.41 | |
|---|---|---|
| specific yield | 0.00012 | |
| elevation of the top plate | −8.40 | m |
| elevation of the bottom plate | −17.94 | m |
| northwest water head | −8.40 | m |
| southeast water head | −8.75 | m |
| rainfall | 549.4 | mm/a |
| precipitation infiltration replenishment coefficient | 0.21 | |
| permeability coefficient Kx | 1.02 | m/d |
| permeability coefficient Kz | 0.1 | m/d |
| longitudinal dispersion | 10 | m |

Pollutant in groundwater is methyl tert-butyl ether with a maximum concentration of 179 μg/L, and a repair target value C₀ of 14 μg/L; Cₜ is the expected concentration value of the repaired groundwater pollutant, where max Cₜ≤C₀ needs to be satisfied. When the condition is not met, the method in this embodiment will not be applied.

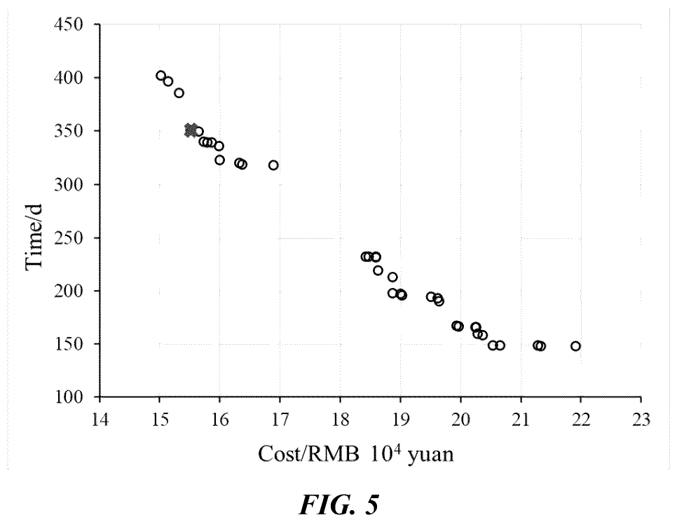

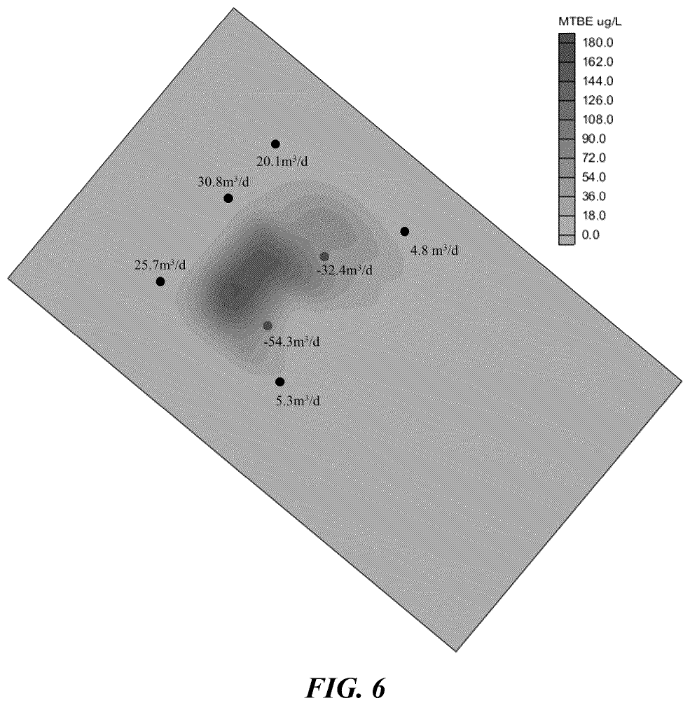

The maximum content of methyl tert-butyl ether in aquifer soil is 45 μg/kg, and the repair target value is 28 μg/kg. The organic carbon content of the soil is 2.9%, and the organic carbon distribution coefficient (Koc) of the methyl tert-butyl ether is 0.16 L/kg. In the case of repairing to the target value (the target value is the content in Table 5), the objective function is established with the minimum fund cost and the shortest time as the objective function:

$$Fund cost minimum : Min J = 3816 {\sum }_{i = 1}^{N} {y}_{i} + 2 {\sum }_{i = 1}^{N} {y}_{i} \vert {Q}_{i} \vert {t}_{i} + 4 {\sum }_{i = 1}^{N} {y}_{i} \vert {Q}_{o} \vert {t}_{o}$$

$$Time cost minimum : Min T = max ( {t}_{i} , {t}_{o} )$$

wherein, the single well construction price of pumping well and injection well is 3816 yuan (400 yuan/m*9.54 meters), the unit price of pumping is 2 yuan/m³, and the unit price of injection is 4 yuan/m³. Using NSGA-II algorithm, with initial population 200 and termination condition 100 generations, a series of Pareto optimal solutions are obtained (as shown in FIG. 5). According to the information available to the decision maker, considering funds and time costs comprehensively, and it is obtained that 2 water pumping wells and 5 water injection wells are used in the site (Table 6, FIG. 6), the repairing time is about 350 days, and the fund cost is 155200 yuan, and the repair target can be achieved.

By setting the objective function, constraint conditions are established according to site conditions, the process of releasing aquifer pollutants to groundwater is also considered, then, a series of solutions of repair time and repair funds are calculated by using NSGA-II algorithm, from which the overall situation of time and funds is displayed, and for a specific optimal solution, a repair process is displayed.

TABLE 5

| | | |
|---|---|---|
| thickness of the wrapping tape H_{b} | 3.5 | m |
| thickness of the aquifer Hₕ | 9.54 | m |
| groundwater repair target value C₀ | 14 | μg/L |
| soil repair target value Cₛ | 28 | μg/kg |

TABLE 6

| sequence | | | | |
|---|---|---|---|---|
| number | X | Y | Q | type |
| 1 | 214 | 219 | 25.7 | injection well |
| 2 | 308 | 335 | 30.8 | injection well |
| 3 | 373 | 411 | 20.1 | injection well |
| 4 | 362 | 157 | −54.3 | pumping well |
| 5 | 441 | 254 | −32.4 | pumping well |
| 6 | 554 | 288 | 4.8 | injection well |
| 7 | 380 | 79 | 5.3 | injection well |

The well group layout parameters of the polluted groundwater remediation determined by the present application can truly reflect the relationship between funds and time under the condition of achieving a repair effect, then the groundwater remediation is performed based on the contaminated groundwater remediation well group layout parameters, so that the remediation efficiency of the contaminated groundwater can be improved.

It should be understood that the sequence number of each step in the foregoing embodiments are not meant to be followed by the execution sequence, the execution order of each process should be determined in its function and internal logic, and should not constitute any limitation on the implementation process of the embodiments of the present application.

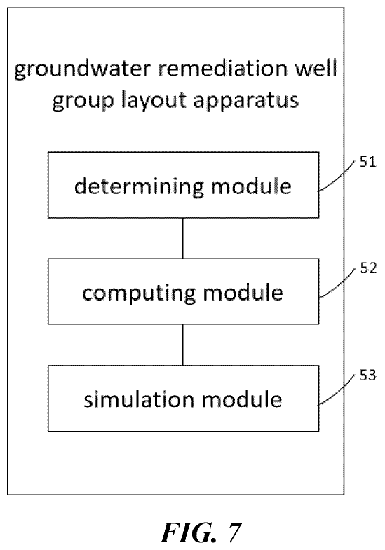

In an embodiment, an apparatus of groundwater remediation well group layout is provided, which has one-to-one correspondence to the method of groundwater remediation well group layout in the above embodiments. As shown in FIG. 7, each functional module of the apparatus is described in detail as follows:
determining module 51 is used to determine N groups of random data and N groups of well position coordinates by means of random and preset constraint conditions of multi-objective optimization NSGA-II algorithm, in which each group of random data includes the maximum number of water pumping wells, the maximum number of water injection wells, the state variables of water wells, the flow of water pumping wells, the flow of water injection wells, the running time of water pumping wells, and the running time of water injection wells; the number of wells in each group is the sum of the number of water pumping wells and the number of water injection wells;
computing module 52 is used to input each group of random data into target function, and calculate fund data and time data respectively corresponding to each group of random data;
simulation module 53 is used to input each group of random data and the corresponding water well position coordinates into groundwater flow field distribution and solute transport model, so that the pollutant concentration after groundwater remediation is obtained through simulation;

The said determining module 51 is also used to determine the random data with the pollutant concentration less than or equal to the repair target value after the polluted groundwater is repaired and the corresponding water well position coordinates as the well group layout parameters of the polluted groundwater repairing.

In an optional embodiment of the present application, the said preset constraint condition at least includes:

$${\sum }_{i = 1}^{{N}_{1}} {y}_{i} \vert {Q}_{i} \vert = {\sum }_{i = 1}^{{N}_{2}} {y}_{i} \vert {Q}_{o} \vert ;$$

$$max {S}_{o} \leq {H}_{b} ; and$$

$$max {S}_{i} \leq {H}_{h} ;$$

wherein, N₁ is the number of water pumping wells, N₂ is the number of water injection wells, yᵢ is the state variables of water wells, Qᵢ is the flow of water pumping wells; Qₒ is the flow of water injection wells, Sₒ is a water head rise value caused by water injection of water injection well; H_{b} is the thickness of the wrapping tape of the stratum; Sᵢ is a water head drop value caused by water pumping of water pumping well; H_{b} is the thickness of the aquifer of the stratum.

In an optional embodiment of the present application, the said preset constraint condition also includes: max Cₜ≤ C₀;
wherein, Cₜ is the predicted pollutant concentration value of the repaired groundwater; C₀ is the repair target value.

In an optional embodiment of the present application, the computing module 52 is specifically used to:

$$J = {α}_{1} {\sum }_{i = 1}^{N} {y}_{i} {d}_{i} + {α}_{2} {\sum }_{i = 1}^{{N}_{1}} {y}_{i} \vert {Q}_{i} \vert {t}_{i} + {α}_{3} {\sum }_{i = 1}^{{N}_{2}} {y}_{i} \vert {Q}_{o} \vert {t}_{o}$$

$$T = max ( {t}_{i} , {t}_{o} )$$

wherein, J is fund data, T is time data, N is the number of water pumping wells and water injection wells, N₁ is the maximum number of water pumping wells, N₂ is the maximum number of water injection wells, yᵢ is the state variables of water wells, dᵢ is the well-forming depth of the i-th well, Qᵢ is the flow of water pumping wells, tᵢ is the running time of the i-th water pumping well, Qₒ is the flow of water injection wells, tₒ is the running time of the i-th water injection well, α₁ is the construction unit price of water pumping well and water injection well, α₂ is the running unit price of water pumping well, α₃ is the running unit price of water injection well.

In an optional embodiment of the present application, the said number of water pumping wells and water injection wells is the sum of the said number of water pumping wells and the said number of water injection wells.

In an optional embodiment of the present application, determining module 51 is also used to determine a group of random data with the minimum time data in the same fund data as target random data, or determine a group of random data with the minimum fund data in the same time data as target random data;

simulation module 53 is used to input each group of random data and the corresponding water well position coordinates into groundwater flow field distribution and solute transport model, so that the pollutant concentration after groundwater remediation is obtained through simulation.

In an optional embodiment of the present application, simulation module 53 is used when there us no same fund data and the same fund data do not exist, to input all random data and the corresponding water well position coordinates into groundwater flow field distribution and solute transport model, so that the pollutant concentration after groundwater remediation is obtained through simulation.

In an optional embodiment of the present application, simulation module 53 is also used to acquire hydrogeological basic parameters required for modeling, the said hydrogeological basic parameters at least including pollution site related data, hydrogeological data, and pollutant related data; simulating the groundwater flow field distribution model according to the said hydrogeological basic parameter simulation, and on the basis of the groundwater flow field, simulate the groundwater solute transport model according to the said pollutant-related data.

For the specific definition of the apparatus, reference may be made to the definition of the method of groundwater remediation well group layout above, and details are not described herein again. All or some of the modules in the foregoing device may be implemented by software, hardware, and their combination. The foregoing modules may be embedded in or independent of processor in computer device in a hardware form, or may be stored in a memory in computer device in the form of software, so that the processor invokes an operation corresponding to each of the above modules.

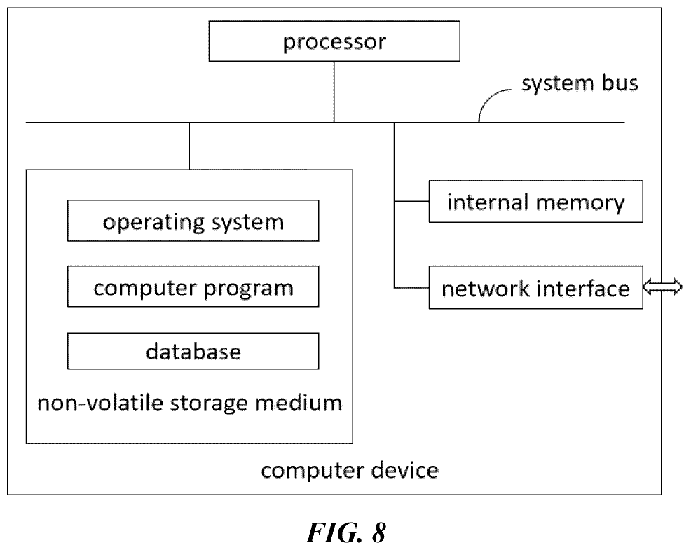

In one embodiment, a computer device is provided, which may be a server, and an internal structure diagram thereof may be as shown in FIG. 8. The computer device includes processor, memory, network interface, and database connected by system bus. Wherein, the processor of the computer device is configured to provide computing and control capabilities. The memory of the computer device includes non-volatile storage medium and internal memory. The non-volatile storage medium stores operating system, computer program, and database. The internal memory provides environment for operation of operating system and computer program in non-volatile storage medium. The network interface of the computer device is configured to communicate with external terminal through network connection. When the computer program is executed by the processor, a method of groundwater remediation well group layout is implemented.

In one embodiment, a computer device is provided, including memory, processor, and computer program stored on the memory and executable on the processor, when the processor executes the computer program, the following steps are implemented:
determining N groups of random data and N groups of well position coordinates by means of random and preset constraint conditions of multi-objective optimization NSGA-II algorithm, each group of random data includes the number of water pumping wells, the number of water injection wells, the state variables of water wells, the flow of water pumping wells, the flow of water injection wells, the running time of water pumping wells, and the running time of water injection wells; the number of wells in each group is the sum of the number of water pumping wells and the number of water injection wells;
inputting each group of random data into target function, and calculating fund data and time data respectively corresponding to each group of random data;
inputting each group of random data and the corresponding water well position coordinates into groundwater flow field distribution and solute transport model, so that the pollutant concentration after groundwater remediation is obtained through simulation;
determining the random data with the pollutant concentration less than or equal to the repair target value after the polluted groundwater is repaired and the corresponding water well position coordinates as the well group layout parameters of the polluted groundwater repairing.

In one embodiment, a computer-readable storage medium is provided, on which a computer program is stored, and when the computer program is executed by a processor, the following steps are implemented:
determining N groups of random data and N groups of well position coordinates by means of random and preset constraint conditions of multi-objective optimization NSGA-II algorithm, each group of random data includes the number of water pumping wells, the number of water injection wells, the state variables of water wells, the flow of water pumping wells, the flow of water injection wells, the running time of water pumping wells, and the running time of water injection wells; the number of wells in each group is the sum of the number of water pumping wells and the number of water injection wells;
inputting each group of random data into target function, and calculating fund data and time data respectively corresponding to each group of random data;
inputting each group of random data and the corresponding water well position coordinates into groundwater flow field distribution and solute transport model, so that the pollutant concentration after groundwater remediation is obtained through simulation;
determining the random data with the pollutant concentration less than or equal to the repair target value after the polluted groundwater is repaired and the corresponding water well position coordinates as the well group layout parameters of the polluted groundwater repairing.

In one embodiment, a computer program product comprising computer program is provided, the computer program being executed by processor to implement the following steps:
determining N groups of random data and N groups of well position coordinates by means of random and preset constraint conditions of multi-objective optimization NSGA-II algorithm, each group of random data includes the number of water pumping wells, the number of water injection wells, the state variables of water wells, the flow of water pumping wells, the flow of water injection wells, the running time of water pumping wells, and the running time of water injection wells; the number of wells in each group is the sum of the number of water pumping wells and the number of water injection wells;
inputting each group of random data into target function, and calculating fund data and time data respectively corresponding to each group of random data;
inputting each group of random data and the corresponding water well position coordinates into groundwater flow field distribution and solute transport model, so that the pollutant concentration after groundwater remediation is obtained through simulation;
determining the random data with the pollutant concentration less than or equal to the repair target value after the polluted groundwater is repaired and the corresponding water well position coordinates as the well group layout parameters of the polluted groundwater repairing.

A person of ordinary skill in the art may understand that all or some of the processes in the method in the foregoing embodiments may be implemented by computer programs instructing related hardware, and the computer program may be stored in non-volatile computer-readable storage medium, and when executed, the computer program may include a flow of the embodiment of the foregoing methods. Any reference to memory, storage, database, or other medium used in the embodiments provided in the present application may include at least one of non-volatile or volatile memory. The non-volatile memory may include read-only memory (ROM), programmable ROM (PROM), electrically programmable ROM (EPROM), electrically erasable programmable ROM (EEPROM), or flash memory. The volatile memory may include random access memory (RAM) or external cache. By way of illustration, and not limitation, RAM may be available in various forms, such as static RAM (SRAM), dynamic RAM (DRAM), synchronous DRAM (SDRAM), dual data rate SDRAM (DDRSDRAM), enhanced SDRAM (ESDRAM), synchlink DRAM (SLDRAM), rambus direct RAM (RDRAM), direct rambus dynamic RAM (DRDRAM), rambus dynamic RAM (RDRAM), and the like.

It can be clearly understood by a person skilled in the art that, for convenience and brevity of description, the divisions of the above functional units and modules are illustrated only with examples, in practical application, the above-mentioned functions can be assigned to different functional units and modules according to needs, that is, the internal structure of the device is divided into different functional units or modules to complete all or part of the functions described above.

The above embodiments are only used to illustrate the technical solutions of the present application, rather than limiting the technical solutions of the present application; although the present application has been described in detail with reference to the foregoing embodiments, It should be understood by those of ordinary skill in the art that the technical solutions recited in the foregoing embodiments may still be modified, or some of the technical features may be replaced equivalently. However, these modifications or substitutions do not make the nature of the corresponding technical solutions separate from the spirit and scope of the technical solutions of the embodiments of the present application, and should be included within the protection scope of the present application.

1. A method of groundwater remediation well group layout, wherein the method includes:
determining N groups of random data and N groups of well position coordinates based on random and preset constraint conditions of multi-objective optimization NSGA-II algorithm, each group of random data includes a number of water pumping wells, a number of water injection wells, state variables of water wells, a flow of water pumping wells, a flow of water injection wells, running time of water pumping wells, and running time of water injection wells, wherein a number of wells in each group is the sum of the number of water pumping wells and the number of water injection wells;
inputting each group of random data into target function, and calculating fund data and time data respectively corresponding to each group of random data;
inputting each group of random data and the corresponding water well position coordinates into a groundwater flow field distribution and solute transport model, so that a pollutant concentration after groundwater remediation is obtained through simulation; and
determining the random data with the pollutant concentration less than or equal to a remediation target value after remediation of polluted groundwater and the corresponding water well position coordinates as the well group layout parameters for remediation of polluted groundwater.

2. The method according to claim 1, wherein the preset constraint condition at least includes:
$${\sum }_{i = 1}^{{N}_{1}} {y}_{i} \vert {Q}_{i} \vert = {\sum }_{i = 1}^{{N}_{2}} {y}_{i} \vert {Q}_{o} \vert ;$$
$$max {S}_{o} \leq {H}_{b} ; and$$
$$max {S}_{i} \leq {H}_{h} ;$$
wherein, N₁ is the number of water pumping wells, N₂ is the number of water injection wells, yᵢ is the state variables of water wells, Qᵢ is the flow of water pumping wells; Qₒ is the flow of water injection wells, Sₒ is a water head rise value caused by water injection of water injection well; H_{b} is a thickness of wrapping tape of the stratum; Sᵢ is a water head drop value caused by water pumping of water pumping well; H_{b} is a thickness of aquifer of the stratum.

3. The method according to claim 2, wherein the preset constraint condition further includes:
$$max {C}_{t} \leq {C}_{0} ;$$
wherein, Cₜ is a predicted pollutant concentration value of remediated groundwater; C₀ is the remediation target value.

4. The method according to claim 1, wherein inputting each group of random data into the target function, and calculating the fund data and time data respectively corresponding to each group of random data includes:
calculating the fund data and the time data through the following objective function:
$$J = {α}_{1} {\sum }_{i = 1}^{N} {y}_{i} {d}_{i} + {α}_{2} {\sum }_{i = 1}^{{N}_{1}} {y}_{i} \vert {Q}_{i} \vert {t}_{i} + {α}_{3} {\sum }_{i = 1}^{{N}_{2}} {y}_{i} \vert {Q}_{o} \vert {t}_{o}$$
$$T = max ( {t}_{i} , {t}_{o} )$$
wherein, J is the fund data, T is the time data, N is the number of water pumping wells and water injection wells, N₁ is the number of water pumping wells, N₂ is the number of water injection wells, yₗ is the state variables of water wells, dᵢ is a well-forming depth of the i-th well, Qᵢ is the flow of water pumping wells, tᵢ is the running time of the i-th water pumping well, Qₒ is the flow of water injection wells, tₒ is the running time of the i-th water injection well, α₁ is a construction unit price of water pumping well and water injection well, α₂ is a running unit price of water pumping well, α₃ is a running unit price of water injection well.

5. The method according to claim 4, wherein the number of water pumping wells and water injection wells is the sum of the number of water pumping wells and the number of water injection wells.

6. The method according to claim 1, wherein before inputting water well position coordinates corresponding to each group of random data into the groundwater flow field distribution and solute transport model, so that the pollutant concentration after groundwater remediation is obtained through simulation, the method also includes:
determining a group of random data with minimum time data in the same fund data as target random data, or determining a group of random data with minimum fund data in the same time data as target random data;
wherein inputting each group of random data and the corresponding water well position coordinates into the groundwater flow field distribution and solute transport model, so that the pollutant concentration after groundwater remediation is obtained through simulation includes:
inputting each group of target random data and the corresponding water well position coordinates into the groundwater flow field distribution and solute transport model, so that the pollutant concentration after groundwater remediation is obtained through simulation.

7. The method according to claim 6, wherein the method also includes:
when there is no same fund data and the same fund data do not exist, inputting all random data and the corresponding water well position coordinates into the groundwater flow field distribution and solute transport model, so that the pollutant concentration after groundwater remediation is obtained through simulation.

8. The method according to claim 1, wherein the method also includes:
acquiring hydrogeological basic parameters required for modeling, the hydrogeological basic parameters at least including pollution site-related data, hydrogeological data, and pollutant-related data;
simulating the groundwater flow field distribution model according to the hydrogeological basic parameter simulation, and on the basis of the groundwater flow field, simulating the groundwater solute transport model according to the pollutant-related data.
